(19) United States
(12) Patent Application Publication
(10) Pub. No.: US 2021/0179119 A1
(43) Pub. Date: Jun. 17, 2021

(54) VEHICLE AND METHOD OF CONTROLLING THE SAME

(71) Applicants: Hyundai Motor Company, Seoul (KR); Kia Motors Corporation, Seoul (KR)

(72) Inventor: Sung Woo LEE, Gwacheon-si (KR)

(73) Assignees: Hyundai Motor Company, Seoul (KR); Kia Motors Corporation, Seoul (KR)

(21) Appl. No.: 16/935,478

(22) Filed: Jul. 22, 2020

(30) Foreign Application Priority Data
Dec. 16, 2019 (KR) 10-2019-0168018

(51) Int. Cl. B60W 50/02; B60W 50/029; B60W 50/04; B60W 50/14; B60W 60/00; B60W 10/20; B60W 10/04

(52) U.S. Cl. CPC B60W 50/0205; B60W 50/029; B60W 50/04; B60W 2050/021; B60W 60/0016; B60W 10/20; B60W 10/04; B60W 50/14

(57) ABSTRACT

A vehicle may include a vehicle driving control device; and a plurality of electronic control devices configured to control the vehicle driving control device, wherein the plurality of electronic control devices includes: a memory configured to store a preset reference; and a processor configured to perform Controller Area Network (CAN) communication with another electronic control device among the plurality of electronic control devices, compare a signal of the Vehicle network communication with the preset reference, and determine whether to control the vehicle driving control device based on a result of the comparison.

### CROSS-REFERENCE TO RELATED APPLICATION

The present application claims priority to Korean Patent Application No. 10-2019-0168018, filed on Dec. 16, 2019, the entire contents of which is incorporated herein for all purposes by this reference.

### BACKGROUND OF THE INVENTION

### Field of the Invention

The present invention relates to a vehicle and a method of controlling the same, and more specifically, to a technology for monitoring Controller Area Network (CAN) communication between a plurality of vehicle control devices provided in a vehicle and controlling the plurality of vehicle control devices.

### Description of Related Art

Control of vehicles includes control of a vehicle body and control of a chassis.

In general, a chassis of a vehicle includes a driving device for driving the vehicle. In addition, the vehicle body refers to a body part that is not associated with the driving device.

Conventionally, the safety control of the driving device is achieved by monitoring battery power or departure control power, and performing vehicle function control or failure diagnosis according to input power of each processor and overall power transition of the vehicle. In other words, the conventional control method of the driving device is a method that requires wiring of a hard wire.

However, the conventional technology has difficulty in providing an appropriate processor in a situation where monitoring of a power supply transition does not operate due to external noise or surge inflow of a power supplier.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a safety control system for a vehicle driving control device that does not require wiring of a hard wire.

Various aspects of the present invention are directed to providing a vehicle electronic control device that monitors Controller Area Network (CAN) communication signals between a plurality of electronic control devices and determines whether to continuously control the vehicle driving control device according to the monitoring result.

Additional aspects of the present invention will be set forth in part in the description which follows, and in part, will be obvious from the description, or may be learned by practice of the present invention.

Various aspects of the present invention are directed to providing a vehicle including: a vehicle driving control device; and a plurality of electronic control devices configured to control the vehicle driving control device, wherein each of the plurality of electronic control devices includes: a memory configured to store a preset reference; and a processor configured to perform Controller Area Network (CAN) communication with another electronic control device among the plurality of electronic control devices, compare a signal of the Vehicle network communication with the preset reference, and determine whether to control the vehicle driving control device based on a result of the comparison.

The electronic control device may transmit at least one of an activation signal, an inactivation signal, or a response signal to the plurality of electronic control devices.

The electronic control device may stop transmitting the activation signal, the inactivation signal, and the response signal based on an intensity of the Vehicle network communication signal and the preset reference.

The vehicle may further include a dark current breaker, wherein the electronic control device may control the dark current breaker to cut off current flowing to the vehicle driving control device when a preset first time has elapsed.

The electronic control device, upon receiving the response signal within a preset first time, may stop transmitting the activation signal to the other electronic control device.

The electronic control device may determine whether the response signal is input from the other electronic control device, and continue to transmit the activation signal for a preset second time.

The electronic control device may transmit the inactivation signal when a preset third time has elapsed.

The electronic control device may determine whether the response signal for the inactivation signal is received, and determine whether to keep the Vehicle network communication based on a result of the determination.

The electronic control device may detect existence of an abnormal signal, and transmit the activation signal to the other electronic control device based on a result of the detection.

The electronic control device may determine at least one of steering information, driving information, or posture information based on a result of the Vehicle network communication, and control the vehicle driving control device to keep driving the vehicle based on a result of the determination.

The vehicle may further include a warning device configured to warn a user of an abnormality of the vehicle, wherein the electronic control device may control the warning device to warn the user of the abnormality regarding at least one of steering, driving, or posture of the vehicle.

Various aspects of the present invention are directed to providing a method of controlling a vehicle, the method including: controlling, by a plurality of electronic control devices, a vehicle driving control device, wherein the controlling includes: performing, by each of the plurality of electronic control devices, Controller Area Network (CAN) communication with another electronic control device among the plurality of electronic control devices, comparing a signal of the Vehicle network communication with a preset reference, and determining whether to control the vehicle driving control device based on a result of the comparison.

The controlling may include transmitting at least one of an activation signal, an inactivation signal, or a response signal to the plurality of electronic control devices.

The controlling may include stopping transmitting the activation signal, the inactivation signal, and the response signal based on an intensity of the Vehicle network communication signal and the preset reference.

The controlling may include cutting off current flowing to the vehicle driving control device when a preset first time has elapsed.

The controlling may include, upon receiving the response signal within a preset first time, stopping transmitting the activation signal to the other electronic control device.

The controlling may include determining whether the response signal is input from the other electronic control device, and continuing to transmit the activation signal for a preset second time.

The controlling may include transmitting the inactivation signal when a preset third time has elapsed.

The controlling may include determining whether the response signal for the inactivation signal is received, and determining whether to keep the Vehicle network communication based on a result of the determination.

The controlling may include detecting existence of an abnormal signal, and transmitting the activation signal to the other electronic control device based on a result of the detection.

The controlling may include determining at least one of steering information, driving information, or posture information based on a result of the Vehicle network communication, and controlling the vehicle driving control device to keep driving the vehicle based on a result of the determination.

The method may further include warning a user of an abnormality of the vehicle, wherein the controlling may include controlling the warning device to warn the user of the abnormality regarding at least one of steering, driving, or posture of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a vehicle according to various aspects of the present invention;

FIG. 2 is a control block diagram illustrating a driving safety system according to various aspects of the present invention;

FIG. 3 illustrates types of autonomous driving control devices according to various aspects of the present invention;

FIG. 4 illustrates a process in which electronic control devices determine the behavior of a vehicle according to various aspects of the present invention;

FIG. 5 illustrates a case in which an electronic control device according to various aspects of the present invention is in an activated state (a wake-up Mode);

FIG. 6 illustrates a case in which an electronic control device according to various aspects of the present invention is in an inactive state (a Sleep Mode); and

FIG. 7 illustrates a preset reference according to one disclosed embodiment.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Like numerals refer to like elements throughout the specification. Not all elements of embodiments of the present invention will be described, and description of what are commonly known in the art or what overlap each other in the exemplary embodiments will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in the exemplary embodiment, specify the presence of stated features, integers, steps, operations, elements, and/or components, but do not preclude the presence or addition of one or more other features, integers, steps, operations, elements, components, and/or groups thereof, unless the context clearly indicates otherwise.

In the description of an exemplary embodiment of the present invention, it will be understood that, when a layer is referred to as being “on/under” another layer or substrate, it can be directly on/under the other layer or substrate, or one or more intervening layers may also be present.

Although the terms “first,” “second,” “A,” “B,” etc. may be used to describe various components, the terms do not limit the corresponding components, but are used only for distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and embodiments of the present invention will be described with reference to the accompanying drawings.

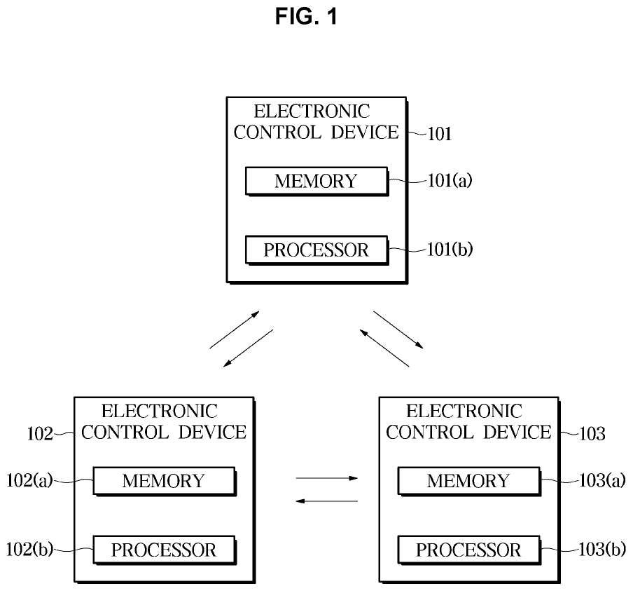

FIG. 1 illustrates that a plurality of electronic control devices 101, 102, and 103 according to a disclosed aspect perform Controller Area Network (CAN) communication and form a Vehicle network communication network.

Referring to FIG. 1, the plurality of electronic control devices may include a first electronic control device 101, a second electronic control device 102, and a third electronic control device 103. Here, the terms “first”, “second”, and “third” do not indicate the number of electronic control devices, and the number of electronic control devices may be greater than three.

The first electronic control device 101 may refer to an electronic control device that receives a signal from the second electronic control device 102 and transmits a signal to the third electronic control device 103.

The second electronic control device 102 may refer to an electronic control device that transmits a signal to the first electronic control device 101.

The third electronic control device 103 may refer to an electronic control device that receives a signal from the first electronic control device 101 and transmits a response signal to the first electronic control device 101.

Furthermore, each of the electronic control devices 101, 102, and 103 forms a CAN communication network between the plurality of electronic control devices 101, 102, and 103, determines an abnormal signal occurring in the network, and determines whether a vehicle driving control device 200 for driving the vehicle is abnormal.

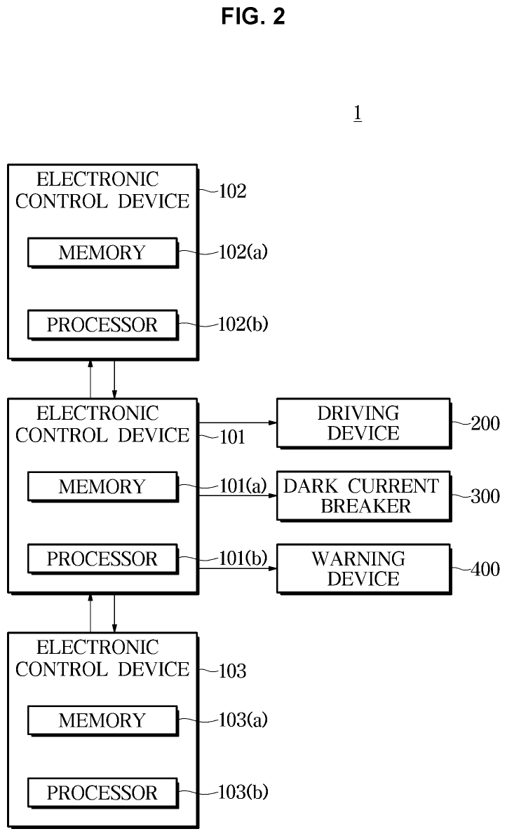

FIG. 2 is a control block diagram illustrating the vehicle 1 according to various aspects of the present invention.

Referring to FIG. 2, the vehicle 1 according to the disclosed embodiment includes a plurality of electronic control devices 101, 102 and 103 and a vehicle driving control device 200, and includes a dark current breaker 300 or a warning device 400. Here, the electronic control devices 101, 102, and 103 include memories 101(a), 102(a), and 103(a), and processors 101(b), 102(b), and 103(b), respectively. Hereinafter, the following description will be made in relation to the electronic control device 101 among the plurality of electronic control devices according to an exemplary embodiment of the present invention.

Specifically, the electronic control device 101 is provided in plural, and the plurality of electronic control devices 101 perform CAN communication with each other, compares the CAN communication signal with a preset reference, and determines the behavior of the vehicle 1. Here, the preset reference may be a reference for determining whether a CAN signal is received from each electronic control device.

Furthermore, the electronic control device 101 may determine whether to control the vehicle driving control device 200 based on the determined behavior state of the vehicle 1. Here, the behavior state of the vehicle 1 may include at least one of steering information, travelling information, or posture information, but is not limited thereto.

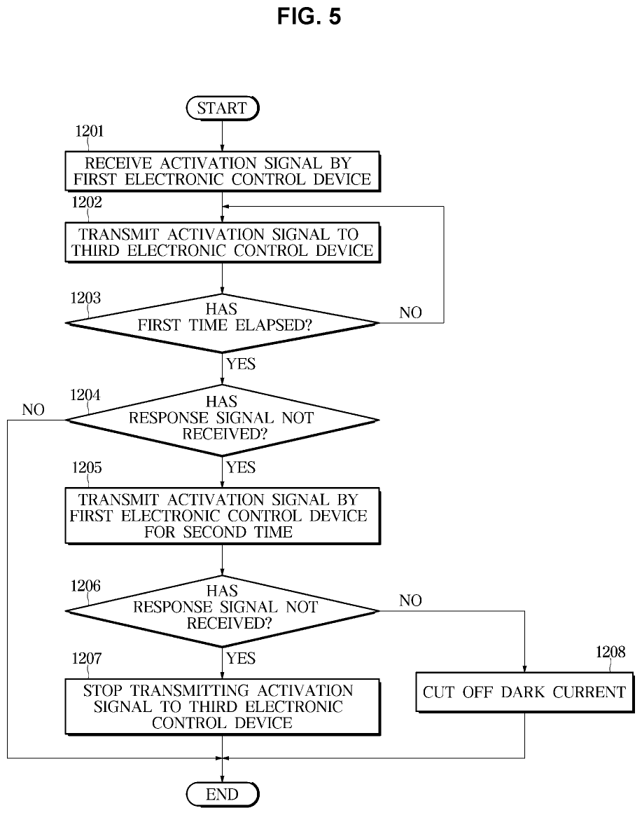

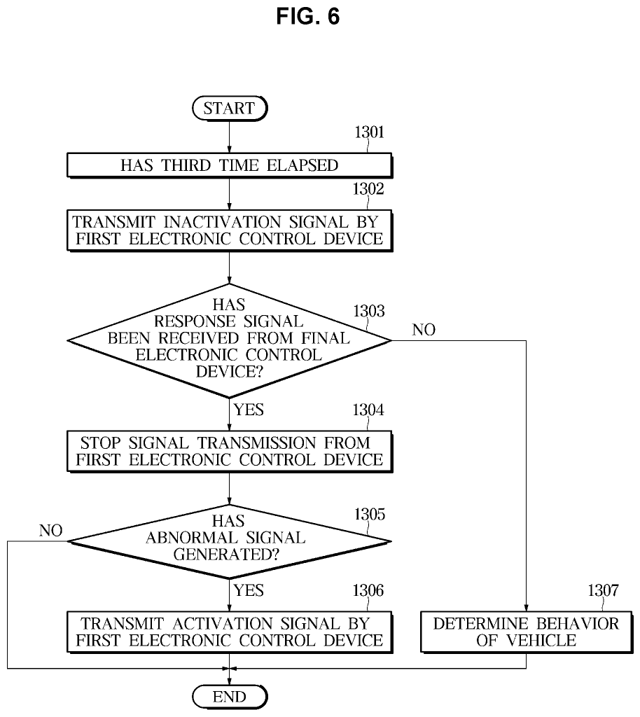

Furthermore, the electronic control device 101 determines whether the received CAN signal is transmitted from which electronic control device or the signal strength, and enters a CAN communication activation mode (Wake Up Mode) or a CAN communication inactivation mode (Sleep Mode) based on the determination result. The process of entering the CAN communication activation mode (Wake Up Mode) or CAN communication inactivation mode (Sleep Mode) will be described below with reference to FIG. 5 and FIG. 6.

Furthermore, the electronic control device 101 may transmit at least one of an activation signal, an inactivation signal, or a response signal to the plurality of electronic control devices, and may stop transmitting the activation signal, the inactivation signal, or the response signal.

The electronic control devices 101, 102, and 103 may each include a memory for storing data regarding an algorithm for controlling the operations of the components of the vehicle 1 or a program that represents the algorithm, and a processor that performs the above described operations using the data stored in the memory. In the instant case, the memory and the processor may be implemented as separate chips. Alternatively, the memory and the processor may be implemented as a single chip.

Furthermore, the electronic control devices 101, 102, and 103 may include a plurality of electronic control devices and communication devices performing each other. The communication device may include one or more components that enable communication with an external device, for example, at least one of a short-range communication module, a wired communication module, or a wireless communication module.

The short-range communication module may include various short-range communication modules that transmit and receive signals using a wireless communication network in a short range, such as a Bluetooth module, an infrared communication module, a radio frequency identification (RFID) communication module, a wireless local access network (WLAN) communication module, an NFC communication module, and a zigbee communication module.

The wired communication module may include not only various wired communication modules, such as a controller area network (CAN) communication module, a local area network (LAN) communication module, a wide area network (WAN) module, or a value added network (VAN) module, but also various cable communication modules, such as a universal serial bus (USB), a high definition multimedia interface (HDMI), a digital visual interface (DVI), a recommended standard 232 (RS-232), power line communication, or plain old telephone service (POTS).

The wireless communication module may include wireless communication modules supporting various wireless communication methods, such as a Wifi module, a wireless broadband module (Wibro) module, a global system for mobile communication (GSM) module, a code division multiple access (CDMA) module, a wideband code division multiple access (WCDMA) module, a universal mobile telecommunications system (UMTS) module, a time division multiple access (TDMA) module, a long term evolution (LTE) module, and the like.

The wireless communication module may include a wireless communication interface including an antenna and a transmitter for transmitting signals. Furthermore, the wireless communication module may further include a signal converting module for converting a digital control signal output from the electronic control devices 101, 102, and 103 through the wireless communication interface into an analog type wireless signal under the control of the electronic control devices 101, 102, and 103.

The wireless communication module may include a wireless communication interface including an antenna and a receiver for receiving signals. Furthermore, the wireless communication module may further include a signal converting module for demodulating an analog type wireless signal received through the wireless communication interface into a digital control signal.

The electronic control devices 101, 102, and 103 may include a storage device that stores a preset reference. The storage device may be implemented as a nonvolatile memory device, such as a cache, a read only memory (ROM), a programmable ROM (PROM), an erasable programmable ROM (EPROM), an electrically erasable programmable ROM (EEPROM), and a flash memory, a volatile memory device, such as a random access memory (RAM), or other storage media, such as a hard disk drive (HDD), a CD-ROM, and the like., but the implementation of the storage device is not limited thereto. The storage device may be a memory implemented as a chip separated from the processor, which has been described above in connection with the electronic control devices 101, 102, and 103, or may be implemented as a single chip integrated with the processor.

The vehicle driving control device 200 according to the disclosed embodiment refers to a configuration which is directly and indirectly linked to the engine and directly related to the driving of the vehicle 1. According to the disclosed embodiment, the vehicle driving control device 200 may include an engine, a power train, a steering device, a braking device, or a suspension system, but is not limited thereto.

Furthermore, the vehicle driving control device 200 according to the disclosed embodiment may be controlled by the electronic control device 101 performing an autonomous driving function.

The dark current breaker 300 according to the disclosed embodiment is a device that blocks the dark current flowing to the vehicle driving control device 200 or the electronic control device 101.

The dark current breaker 300 cuts off dark current flowing to the vehicle driving control device 200 or the electronic control device 101 when CAN communication between a plurality of electronic control devices 101, 102, and 103 is interrupted, when the CAN communication network is in an inactive state (Sleep Mode), when the vehicle 1 is normally driving, or when an abnormality occurs in a part of the components of the vehicle driving control device 200.

The warning device 400 according to the disclosed embodiment warns the user of the abnormality of the vehicle 1.

When CAN communication between the plurality of electronic control devices 101, 102, and 103 is interrupted, the processors 101(b), 102(b), and 103(b) provided in the respective electronic control device 101, 102, and 103 determine a component of the vehicle driving control device 200 controlled by the electronic control device causing the communication interruption, and the warning device 400 warns the user of a malfunction of the corresponding component. Here, the components of the vehicle driving control device 200 may include an engine, a power train, a steering device, a braking device, or a suspension system, but are not limited thereto.

Furthermore, the warning method of the warning device 400 may be a method of informing a user of a malfunctioning configuration through a user terminal or a display, but is not limited thereto.

Here, the user terminal may be implemented as a computer or a portable terminal configured for connecting to the vehicle 1 through a network. Here, the computer may include, for example, a notebook computer, a desktop computer, a laptop PC, a tablet PC, a slate PC, and the like, each of which is provided with a WEB Browser. The portable terminal is a wireless communication device mobility, and may include: all types of handheld based wireless communication devices, such as a personal communication system (PCS), a global system for mobile communications (GSM), a personal digital cellular (PDC), a personal handy phone system (PHS), a personal digital assistant (PDA), an international mobile telecommunication (IMT)-2000, a code division multiple access (CDMA)-2000, a w-code division multiple access (W-CDMA), a wireless broadband internet (WiBro) terminal, a smart Phone, and the like; and wearable devices, such as a watch, a ring, a bracelet, an ankle bracelet, a necklace, glasses, a contact lens, or a head-mounted-device (HMD).

Furthermore, the display may include a cathode ray tube (CRT), a digital light processing (DLP) panel, a plasma display panel, a liquid crystal display (LCD) panel, an electro luminescence (EL) panel, an electrophoretic display (EPD) panel, an electrochromic display (ECD) panel, a light emitting diode (LED) panel or an organic light emitting diode (OLED) panel, but is not limited thereto.

At least one component may be added or omitted according to the performances of the components of the vehicle 1 shown in FIG. 2. Furthermore, the mutual positions of the components may be changed to correspond to the performance or structure of the system.

Meanwhile, the components shown in FIG. 2 may refer to a software component and/or a hardware component, such as a Field Programmable Gate Array (FPGA) and an Application Specific Integrated Circuit (ASIC).

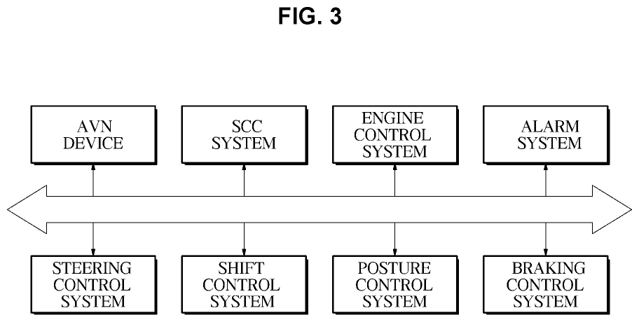

FIG. 3 illustrates types of autonomous driving systems controlled by the electronic control devices 101, 102, and 103 according to various aspects of the present invention.

The electronic control devices 101, 102, and 103 according to the disclosed embodiment control the vehicle driving control device 200 of the vehicle 1.

Specifically, the plurality of electronic control devices 101, 102, and 103 according to the disclosed embodiment may be devices for controlling Audio Video Navigation (AVN) devices, smart cruise control (SCC) systems, engine control systems (ECS), alarm systems, steering control systems (Motor Driven Power Steering: MDPS), shift control systems, electronic stability control (ESC) systems, or braking control systems (EBP, EVP), but are not limited thereto.

Furthermore, each of the electronic control devices 101, 102, and 103 may perform CAN communication with each other and monitor the communication status. As a result, each of the electronic control device 101, 102, and 103 may form a CAN communication network.

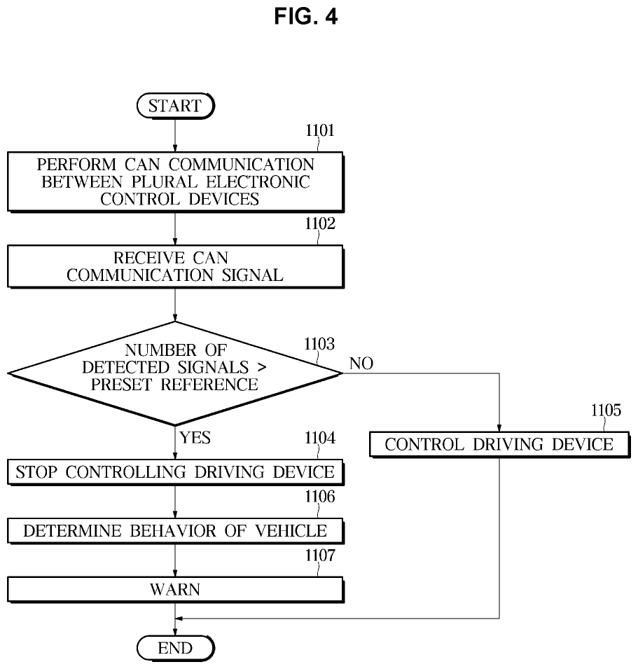

FIG. 4 illustrates a process in which the electronic control devices 101, 102, and 103 determine the behavior of the vehicle 1 according to various aspects of the present invention.

The plurality of electronic control devices 101, 102, and 103 perform CAN communication with each other (1101). The number of CAN communication signals received by the first electronic control device 101 may be a plurality of signals.

The first electronic control device 101 receives a CAN communication signal transmitted from another electronic control device 102 (1102).

When the CAN communication signal is received, the first electronic control device 101 determines whether the number of detected signals exceeds a preset reference (1103).

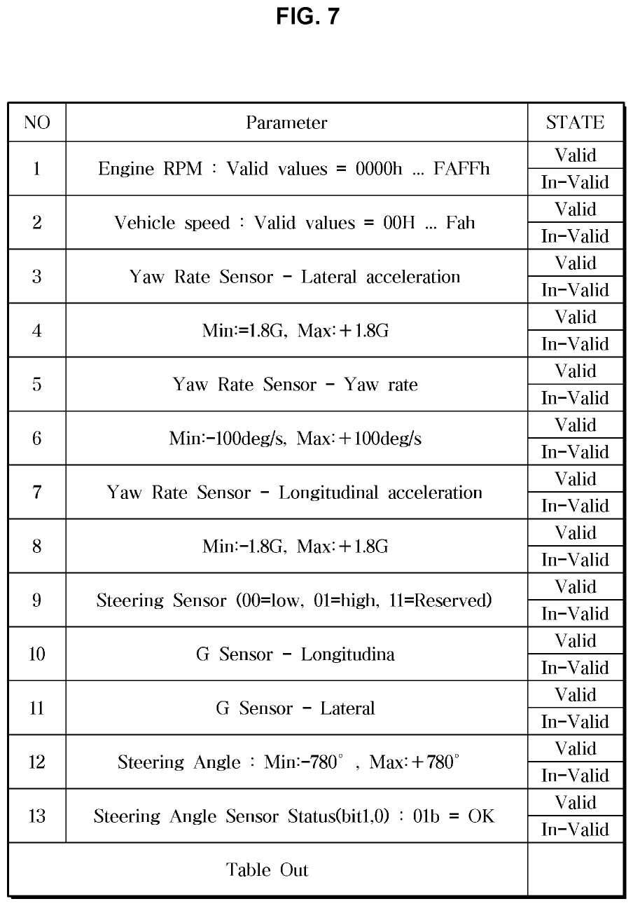

Here, the preset reference may be a Look Up Table as shown in FIG. 7. When it is determined that the number of detected signals is equal to or less than the preset reference, the first electronic control device 101 is not restricted by the detection result of the second electronic control device 102 and continues to control the vehicle driving control device 200 of the vehicle 1 (1105). However, when it is determined that the number of detected signals exceeds the preset reference, the first electronic control device 101 stops controlling the vehicle driving control device 200 (1104), and is restricted by the detection result of the second electronic control device 102.

For example, when the preset reference is 7 and the number of CAN communication signals received by the first electronic control device 101 is 1 to 7, the first electronic control device 101 continues to control the vehicle driving control device 200 without being restricted by the detection result of the second electronic control device 102. However, when the number of CAN communication signals received by the first electronic control device 101 exceeds 7, the first electronic control device 101 stops control of the vehicle driving control device 200 and is restricted by the detection result of the second electronic control device 102.

When it is determined that the number of detected signals exceeds the preset reference, the first electronic control device 101 may determine the behavior of the vehicle 1 (1106).

Here, the behavior of the vehicle 1 may include steering, driving, or posture information of the vehicle 1, but is not limited thereto. When it is determined that the number of detected signals exceeds a preset reference, the first electronic control device 101 determines another component of the vehicle driving control device 200 having a malfunction, and determines the behavior of the vehicle 1.

For example, when it is determined that an abnormality has occurred in the posture control device of the vehicle 1, the first electronic control device 101 may determine that the posture of the vehicle 1 is abnormal, and may determine the degree to which the axle is inclined. However, this is only an example, and the first electronic control device 101 may determine various behaviors of the vehicle 1.

Furthermore, when the number of CAN communication signals received by the first electronic control device 101 exceeds the preset reference, the first electronic control device 101 may control the warning device 400 to warn the user 400 of an abnormality in the vehicle driving control device 200 (1107).

The warning method of the warning device 400 may be a method of informing a user of a malfunctioning configuration through a user terminal or a display, but is not limited thereto.

For example, when the number of CAN communication signals received by the first electronic control device 101 exceeds 7, the first electronic control device 101 determines an abnormality in the component of the vehicle driving control device 200, and when it is determined that the component having the abnormality is a vehicle dynamics control device of the vehicle, the first electronic control device 101 controls the warning device 400 to warn the user of a malfunction of the vehicle dynamics control of vehicle 1.

FIG. 5 illustrates a case in which the electronic control devices 101, 102, and 103 according to various aspects of the present invention are in an activated state (a Wake-UP Mode).

The first electronic control device 101 according to the disclosed embodiment receives an activation signal (Alive) from the second electronic control device 102 (1201), and transmits an activation signal to the third electronic control device 103 that has not generated an activation signal. (1202).

After transmission of the activation signal to the third electronic control device 103, the first electronic control device 101 determines whether a response signal is received from the third electronic control device 103 within a preset first time (1203 and 1204).

Here, the first time refers to a set time required for the first electronic control device 101 to receive a response signal from the third electronic control device 103. The first time is not a fixed value, but may vary depending on user definition, vehicle type, or vehicle condition.

When the first time has elapsed and the response signal for the activation signal transmission has not been received from the third electronic control device 103, the first electronic control device 101 may additionally transmit the activation signal for a second time (1205).

Here, the second time refers to a time during which additional transmission of activation signals does not affect the electronic control devices 101, 102, 103, and 103. The second time is not a fixed value, and may vary depending on user definition, vehicle type, or vehicle condition.

However, when the first time has not elapsed, the first electronic control device 101 may continue to transmit an activation signal to the third electronic control device 103.

Furthermore, when the response signal is received from the third electronic control device 103 within the first time, the first electronic control device 101 normally process the receive response signal and ends the control process.

When the second time has elapsed, the first electronic control device 101 may determine whether a response signal for activation signal transmission has been received (1206).

When the second time has elapsed and the response signal has not been received, the first electronic control device 101 stops transmitting the activation signal to the third electronic control device 103 (1207).

However, when the response signal has been normally received, the first electronic control device 101 processes the reception of the response signal and controls the dark current breaker 300 to cut off current flowing to the vehicle driving control device 200 or the plurality of electronic control devices 101, 102, and 103 (1208).

With such a control process, while normal control is being performed by the electronic control device, system stability may be improved from noise caused by dark current, surge, or disturbance.

FIG. 6 illustrates a case in which the electronic control devices 102, 103, and 103 according to various aspects of the present invention are in an inactive state (a Sleep Mode).

Referring to FIG. 6, the electronic control devices 101, 102, and 103 transmit and receive inactivation signals to and from each other when a preset third time has elapsed (1301 and 1302). Here, the preset third time refers to a time taken for the vehicle 1 to be turned off or enter a state in which the vehicle 1 does not require autonomous driving. The following description will be made based on the first electronic control device 101. However, other electronic control devices 102 and 103 may also perform the same function.

When the third time has elapsed and the inactivation signal has been transmitted, the first electronic control device 101 determines whether a response signal has been received from the electronic control device that has finally received the inactivation signal (1303).

When it is determined that the response signal has been received from the electronic control device that has finally received the inactivation signal, the first electronic control device 101 stops transmitting the inactivation signal and enters a sleep mode (1304).

However, when a response signal has not been received from the electronic control device that has finally received the inactivation signal, the first electronic control device 101 determines whether the behavior of the vehicle 1 is abnormal (1307). As described above, the behavior of the vehicle 1 may include steering, driving, or posture information, but is not limited thereto.

The electronic control device may determine whether an abnormal signal has been generated from one of the plurality of electronic control devices 101, 102, 103, and 103 in an inactive mode (1305).

Here, the dark current breaker 300 may cut off current flowing to the electronic control devices 101, 102, and 103. As a result, the first electronic control device 101 may detect only a pure abnormal signal generated from the electronic control devices 101, 102, and 103 rather than disturbance, noise, or surge waveform.

When it is determined that an abnormal signal has been generated from one of the plurality of electronic control devices 101, 102, and 103, the first electronic control device 101 transmits an activation signal to other electronic control devices 102 and 103 and enters CAN communication activation mode (Wake up Mode) (1306). However, when an abnormality signal has not been generated from one of the plurality of electronic control devices 101, 102, and 103, the first electronic control device 101 does not transmit a separate activation signal and ends a control process.

FIG. 7 illustrates a preset reference according to one included embodiment.

Specifically, the preset reference includes a look up table. The preset reference includes information related to steering, posture, or speed, of the vehicle 1.

Referring to FIG. 7, the disclosed table includes parameters of the vehicle driving control device 200 controlled by the electronic control devices 101, 102, and 103 according to identification numbers.

Specifically, identification numbers 1, 2, 10 and 11 refer to information whether the electronic control device 101 has received a signal from the electronic control device that controls the speed of the vehicle 1. Furthermore, identification numbers 3 to 7 refers to information whether the electronic control device 101 has received a signal from the electronic control device that controls the posture of the vehicle 1. Furthermore, identification numbers 8, 9, 12, and 13 refer to whether the electronic control device 101 has received a signal from the electronic control device that controls the speed of the vehicle 1.

In each identification number, the electronic control devices 101, 102, and 103 determine the current state to be a valid state upon receiving a signal from the electronic control device controlling the configuration of the vehicle driving control device 200, and determine the current state to be an in-valid state upon not receiving the signal.

Furthermore, when a value corresponding to the identification number determined to be the valid state exceeds a preset reference, the electronic control devices 101, 102, and 103 determine that an abnormality has occurred in the vehicle driving control device 200 and stop control of driving.

However, when the value corresponding to the identification number determined to be an in-valid state is below the preset reference, the electronic control devices 101, 102, and 103 may continue to control the vehicle driving control device 200 without being restricted by the determination of other electronic control devices.

Meanwhile, the disclosed exemplary embodiments may be embodied in a form of a recording medium storing instructions executable by a computer. The instructions may be stored in a form of program code, and when executed by a processor, may generate a program module to perform the operations of the included exemplary embodiments. The recording medium may be embodied as a computer-readable recording medium.

The computer-readable recording medium includes all kinds of recording media in which instructions which may be decoded by a computer are stored, for example, a Read Only Memory (ROM), a Random-Access Memory (RAM), a magnetic tape, a magnetic disk, a flash memory, an optical data storage device, and the like.

As is apparent from the above, the vehicle and the method of controlling the same can compare a result of CAN communication between a plurality of electronic control devices with a pre-stored look up table, and determine whether to control the vehicle based on a result of the comparison.

Furthermore, with the above-described configuration, the safety control of vehicle driving can be achieved without wiring of a hard wire.

Furthermore, without wiring of a hard wire, the stability of the system can be ensured from surge waveforms, disturbances, or noise.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described in order to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle comprising:
a vehicle driving control device configured for driving the vehicle; and
a plurality of electronic control devices engaged to the vehicle driving control device and configured to control the vehicle driving control device,
wherein each of the plurality of electronic control devices includes:
a memory configured to store a predetermined reference; and
a processor connected to the memory and configured to perform vehicle network communication with another electronic control device among the plurality of electronic control devices, to compare a signal of the vehicle network communication with the predetermined reference, and to determine whether to control the vehicle driving control device according to a result of the comparison.

2. The vehicle of claim 1, wherein each electronic control device is configured to transmit at least one of an activation signal, an inactivation signal, or a response signal to the plurality of electronic control devices.

3. The vehicle of claim 2, wherein each electronic control device is configured to stop transmitting the activation signal, the inactivation signal, and the response signal according to an intensity of the vehicle network communication signal and the predetermined reference.

4. The vehicle of claim 2, further including a dark current breaker, wherein at least one of the electronic control devices is configured to control the dark current breaker to cut off current flowing to the vehicle driving control device upon determining that a predetermined first time period has elapsed after the transmitting the at least one of the activation signal, the inactivation signal, or the response signal to the plurality of electronic control devices.

5. The vehicle of claim 2, wherein each electronic control device, upon receiving the response signal within a predetermined first time period after the transmitting the at least one of the activation signal, the inactivation signal, or the response signal to the plurality of electronic control devices, is configured to stop transmitting the activation signal to the other electronic control device among the plurality of electronic control devices.

6. The vehicle of claim 5, wherein each electronic control device is configured to determine whether the response signal is input from the other electronic control device, and to continue to transmit the activation signal for a predetermined second time period.

7. The vehicle of claim 2, wherein each electronic control device is configured to transmit the inactivation signal upon determining that a predetermined third time period has elapsed for the vehicle to be turned off or to enter a state in which the vehicle does not require autonomous driving.

8. The vehicle of claim 7, wherein each electronic control device is configured to determine whether the response signal for the inactivation signal is received, and is configured to determine whether to keep the vehicle network communication according to a result of the determination of whether the response signal for the inactivation signal is received.

9. The vehicle of claim 8, wherein each electronic control device is configured to detect existence of an abnormal signal in at least one of the plurality of electronic control devices, and to transmit the activation signal to the other electronic control device among the plurality of electronic control devices according to a result of the detection of the existence of the abnormal signal.

10. The vehicle of claim 1, wherein the electronic control device is configured to determine at least one of steering information, driving information, or posture information according to a result of the vehicle network communication, and is configured to control the vehicle driving control device to keep driving the vehicle according to a result of on the determination of the at least one of the steering information, the driving information, and the posture information.

11. The vehicle of claim 1, further including a warning device configured to warn a user of an abnormality of the vehicle,
wherein each electronic control device is configured to control the warning device to warn the user of the abnormality regarding at least one of steering, driving, or posture of the vehicle.

12. A method of controlling a vehicle, the method comprising:
controlling, by a plurality of electronic control devices, a vehicle driving control device configured for driving the vehicle,
wherein the controlling includes:
performing, by each of the plurality of electronic control devices, vehicle network communication with another electronic control device among the plurality of electronic control devices, comparing a signal of the vehicle network communication with a predetermined reference, and determining whether to control the vehicle driving control device according to a result of the comparison.

13. The method of claim 12, wherein the controlling includes transmitting at least one of an activation signal, an inactivation signal, or a response signal to the plurality of electronic control devices.

14. The method of claim 13, wherein the controlling includes stopping transmitting the activation signal, the inactivation signal, and the response signal according to an intensity of the vehicle network communication signal and the predetermined reference.

15. The method of clam 13, wherein the controlling includes cutting off current flowing to the vehicle driving control device upon determining that a predetermined first time period has elapsed after the transmitting the at least one of the activation signal, the inactivation signal, or the response signal to the plurality of electronic control devices.

16. The method of claim 13, wherein the controlling includes, upon receiving the response signal within a predetermined first time period, stopping transmitting the activation signal to the other electronic control device among the plurality of electronic control devices.

17. The method of claim 15, wherein the controlling includes determining whether the response signal is input from the other electronic control device among the plurality of electronic control devices, and continues to transmit the activation signal for a predetermined second time period.

18. The method of claim 13, wherein the controlling includes transmitting the inactivation signal upon determining that a predetermined third time period has elapsed for the vehicle to be turned off or to enter a state in which the vehicle does not require autonomous driving.

19. The method of claim 18, wherein the controlling includes determining whether the response signal for the inactivation signal is received, and determining whether to keep the vehicle network communication according to a result of on the determination of whether the response signal for the inactivation signal is received.

20. The method of claim 19, wherein the controlling includes detecting existence of an abnormal signal in at least one of the plurality of electronic control devices, and transmitting the activation signal to the other electronic control device among the plurality of electronic control devices according to a result of the detection of the existence of the abnormal signal.

21. The method of claim 12, wherein the controlling includes determining at least one of steering information, driving information, or posture information according to a result of the vehicle network communication, and controlling the vehicle driving control device to keep driving the vehicle according to a result of on the determination of the at least one of the steering information, the driving information, or the posture information.

22. The method of claim 12, further including warning a user of an abnormality of the vehicle,
wherein the controlling includes controlling the warning device to warn the user of the abnormality regarding at least one of steering, driving, or posture of the vehicle.
